(19) United States
(12) Patent Application Publication
(10) Pub. No.: US 2008/0095203 A1
(43) Pub. Date: Apr. 24, 2008

(54) Multi-emitter image formation with reduced speckle

(76) Inventors: Alexandre M. Bratkovski, Mountain View, CA (US); Shih-Yuan Wang, Palo Alto, CA (US); M. Saiful Islam, Sacramento, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/584,475

(22) Filed: Oct. 19, 2006

(51) Int. Cl. H01S 3/10

(52) U.S. Cl. 372/26

(57) ABSTRACT

A technique for reducing speckle in a projected image includes forming an image using a plurality of laser light emitters. An input to the plurality of laser light emitters is non-mechanically perturbed to a degree sufficient to disrupt wavefront uniformity across the array of laser light emitters.

### BACKGROUND

Whether for home theatre, business meetings, or advertising, there seems to be desire for ever larger displays. Unfortunately, many display technologies do not scale well as size is increased. Providing large format displays with high contrast and brightness has proven to be a challenge.

One display technology which has had success in large formats is projection. Projection techniques are presently used in portable projectors, large screen televisions, kiosks, and other applications. Typical projection systems include a white light source, a color wheel, a modulation means to impress the image upon the light, and projection optics to project the image onto a screen. The image size is a function of the distance between the projection optics and the screen and the optics of the projector. While large images can be formed using projection techniques, the brightness of images tends to drop as images become very large. As compared to direct display approaches, such as cathode ray tubes and backlight liquid crystal displays, projected images tend to provide lower levels of brightness and contrast.

While the brightness of a projection system can be increased by increasing the intensity of the white light source, the increased heat and higher temperatures of the light source can reduce lifetime and reliability of the light source. Moreover, most white light sources tend to be relatively inefficient, as much of the energy input to the light source is wasted as heat or lost when the light is passed through the color wheel. Increasing the intensity of the light source is often undesirable, as the increased power consumption can result in larger power supplies, increased cooling equipment, and bulkier equipment.

Colored light sources, such as lasers have been considered for use in displays to provide increased brightness. Lasers, however, present a number of challenges that have limited their acceptance in display technology. Because lasers are approximately point sources, they are raster-scanned to produce an image. To form images that appear continuous, the laser is therefore scanned at a very high rate. The laser can be intensity modulated to form individual pixels, however this modulation is also at a very high rate. Because the dwell time of the laser for individual pixels is small, brightness can be limited. Higher output power lasers, while providing brighter images, can result in eye safety hazards. Another problem with lasers is that they tend to produce spatially coherent radiation. The spatially coherent wavefront can produce speckle when reflected from a rough surface, such as a screen. Even microscopic variations in the screen surface can produce objectionable speckle if the light source is highly coherent.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is a schematic diagram of a projection system in accordance with an embodiment of the present invention;

FIG. 2 is a schematic diagram of a projection system using an array of N×N laser light emitters in accordance with another embodiment of the present invention;

FIG. 3 is a schematic diagram of an array of laser light emitters in accordance with an embodiment of the present invention;

FIG. 4 is a schematic diagram of an array of laser light emitters in accordance with another embodiment of the present invention;

FIG. 5 is a circuit diagram of a chaotic signal generator for non-mechanically perturbing a light emitting means in accordance with an embodiment of the present invention; and

FIG. 6 is a flow chart of method for reducing speckle in an image projected by an array of light emitters in accordance with an embodiment of the present invention.

### DETAILED DESCRIPTION OF EXAMPLE EMBODIMENTS

In describing embodiments of the present invention, the following terminology will be used.

The singular forms “a,” “an,” and “the” include plural referents unless the context clearly dictates otherwise. Thus, for example, reference to “an emitter” includes reference to one or more of such emitters.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “about” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill in the art.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to 10” should be interpreted to include not only the explicitly recited values of about 1 to 10, but also include individual values and sub-ranges within the indicated range. Thus, included in this numerical range are individual values such as 2, 3, and 4, and sub-ranges such as 1-2, 2-5, and 5-9, etc.

Reference will now be made to the exemplary embodiments illustrated, and specific language will be used herein to describe the same. It will nevertheless be understood that no limitation of the scope of the invention is thereby intended.

It has been recognized that a projection system can provide improved performance by using a plurality of means for emitting light to cooperatively form an image. A means for non-mechanically perturbing the plurality of means for emitting light to disrupt waveform uniformity can help to reduce speckle in the image.

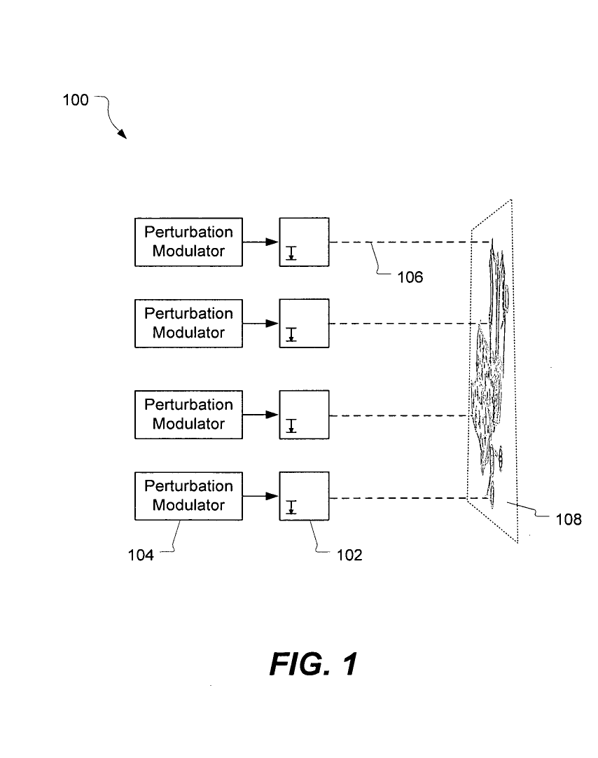

For example, FIG. 1 provides a schematic diagram of a projection system in accordance with an embodiment of the present invention. The projection system, shown generally at 100, includes a plurality of light emitters 102 in an array for emitting light. Each light emitter is capable of emitting a beam 106 to form a portion of the image 108. For example, each laser light emitter may form one or more pixels of the image. The use of laser light emitters helps to provide improved efficiency relative to thermal light sources, such halogen or metal halide lamps. Use of multiple light emitters also helps to increase brightness of the image as compared to using a single laser light emitter. Increased brightness can also help to provide higher contrast in the projected image.

As laser light tends to be coherent, coupled to the laser light emitters are perturbation modulators 104 for non-mechanically perturbing the light emitters. The perturbation modulators vary an input to the light emitters to disrupt wavefront uniformity across the array of laser light emitters 102. This helps to reduce speckle in the image 108 by reducing the coherence of the emitted light. For example, the perturbation modulators can be electrical circuits that produce a chaotic signal. The chaotic signal can be used to vary an electrical input to the light emitter, such as a drive current. As another example, the perturbation modulators can be optical feedback systems that feedback a portion of the optical output of the light emitters back into the light emitters.

One advantage of the system 100 is that the intensity of individual laser light emitters 102 can be reduced relative to a system that uses a single laser light emitter without sacrificing brightness in the image. For example, an array of N×N laser light emitters emitting incoherently with respect to each other can provide a brightness increase of N² relative to a system using a single laser light emitter for the same image size. This can help to reduce the risk of eye injury. In addition to the N² brightness increase, individual laser light emitters need not be scanned as rapidly, or over as wide an angular range, since each laser light emitter can form a portion of the image. The laser light emitters can be modulated to form pixels of the image, for example, by varying the brightness (intensity), color (wavelength), or both. For example, a laser light emitter may be simultaneously modulated and scanned across a region to provide varying illumination for different points on a screen corresponding to a desired brightness, color, or both for pixels at the different points.

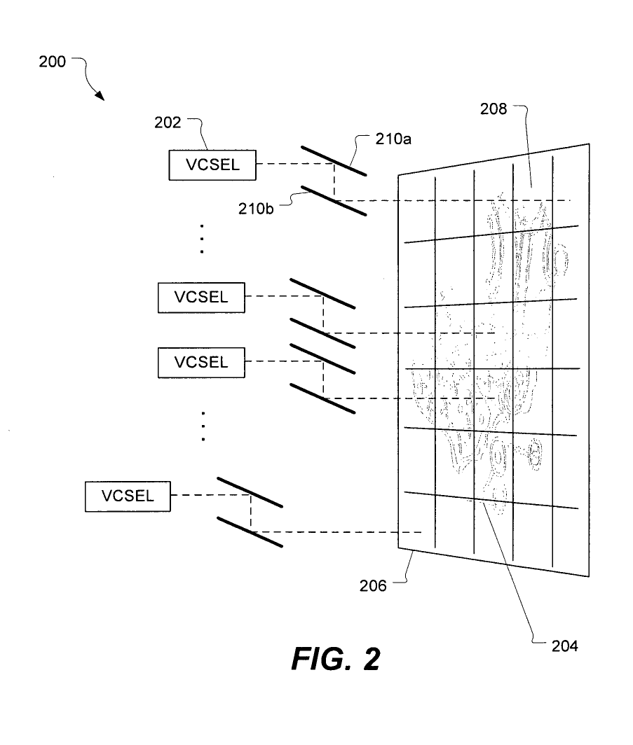

For example, FIG. 2 illustrates one embodiment of a projection system 200 using an array of N×N laser light emitters 202. An image 204 being projected onto a screen 206 is decomposed into an N×N array of patches 208. One laser light emitter forms each patch of the image through an optical scanning subsystem. For example, the optical scanning subsystem may be provided by scanning mirrors 210a, 210b associated with the light emitters to steer the emitted light beam across the area corresponding to the patch. The scanning mirrors may be, for example, galvo mirrors, digital mirror devices, grating light valves, or the like. Modulation of light intensity per pixel may be by direct modulation of the laser light emitter intensity, or controlled by dwell time of the laser using the scanning mirrors.

Each patch may correspond to one pixel or may correspond to multiple pixels of the image. For example, a 1280×760 pixel image may be formed using an array of 1280×760 light emitters, a total of 972,800 light emitters. While this is a large number of laser light emitters, multiple light emitters may be formed on a common substrate using semiconductor processing techniques. For example, large arrays of laser light emitters may be formed using vertical cavity surface emitting lasers (VCSELs) fabricated on a common substrate.

Alternately, the patches may correspond to several pixels of the image. For example, a patch may be N×M pixels. For example, a patch may include 4 pixels (arranged in a 2×2 square), 4 pixels (arranged in a 1×4 row), 12 pixels (arranged as a 3×4 rectangle), 100 pixels (arranged in a 100×100 square), etc.

Different mappings of pixels to patches may be used, and the mapping need not be constant. A multi-resolution projection system may use a variable number of pixels per patch, depending on the resolution being projected. For example, an array of 100 by 100 light emitters may be switched between resolution modes of 1024×768, 1280×720, 1920×1080, and 1600×1200 by varying the patch size so that N varies between about 10 to about 20 and M varies between about 7 to about 12. For some resolution modes, it may be helpful to use only some of the light emitters in the array. It should also be appreciated that not all patches need be the same size in pixels. Depending on the particular application for which the projection system is intended, different combinations of resolution and number of light emitters may be used.

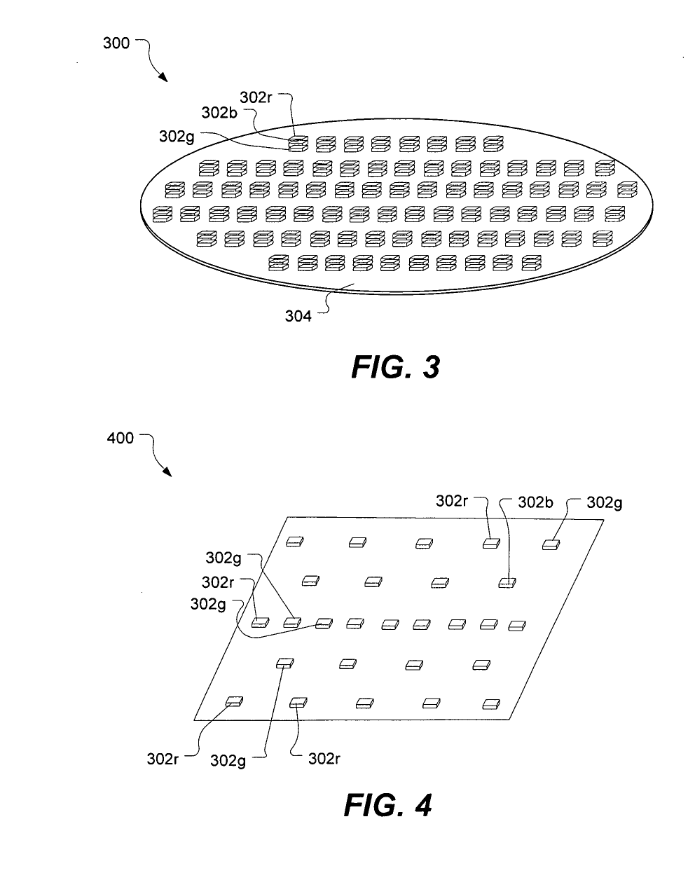

By including laser light emitters for each of the additive primary colors, color images can be provided. For example, as illustrated in FIG. 3, an array of laser light emitters 300 may be arranged in a rectangular array, where each laser light emitter includes a red laser 302r, green laser 302g, and blue laser 302b. The laser light emitters may be formed on a common substrate 304. As another example, as illustrated in FIG. 4, an array of laser light emitters 400 may be in a somewhat irregular regular pattern, and may include interspersed light emitters for the red 402r, green 402g, and blue 402b primaries.

In another embodiment, the laser light emitters may be ultraviolet sources that interact with an ultraviolet-fluorescent screen to produce the image. For example, a screen may include material which emits different wavelengths of visible light in response to different wavelengths of ultraviolet illumination to allow multiple colors to be produced. It will be appreciated that ultraviolet light emitters may be used advantageously in a rear projection system, since the risk of eye damage due to the ultraviolet radiation is reduced.

Returning to FIG. 1, including a means for non-mechanically perturbing the light emitters, such as perturbation modulators 104, helps to reduce speckle effects that may otherwise be produced by the light emitters due to coherent, uniform wavefronts. Various means for non-mechanically perturbing the light emitters can be used. For example, a means for chaotically varying an electrical input to the light emitter can be a chaotic signal generator coupled to the light emitter so that a chaotic signal provides a drive current for the light emitter. As another example, a means for optically reflecting a portion of emitted laser light back into the means for emitting laser light can be a mirror positioned to reflect a portion of the beam back into the laser light emitter.

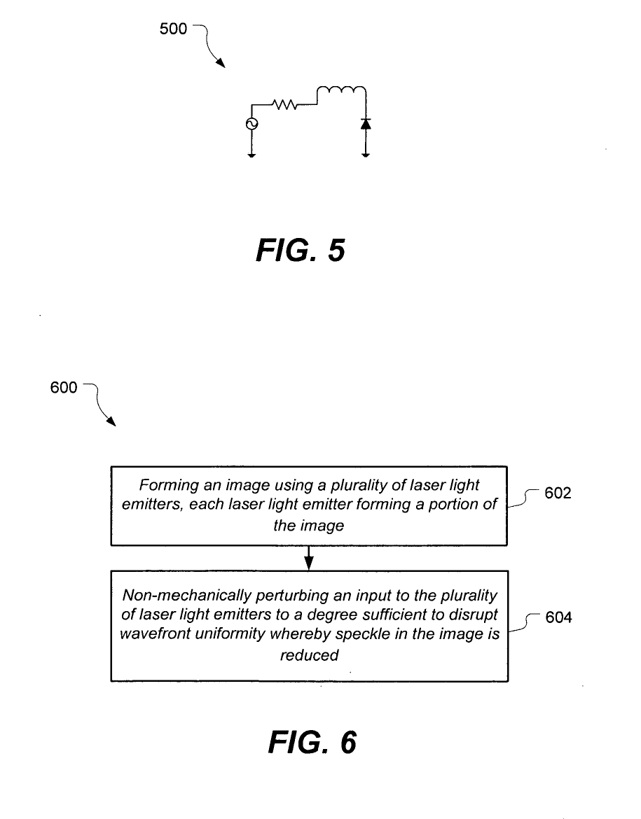

A chaotic signal generator can be provided by a chaotic system for which an electrical output is produced, where the output is unpredictable. Residual time coherence of the emitted light can be shorter than the refresh time for the image, for example, in excess of 80 Hz to reduce speckle perception by the viewer. This unpredictability can be caused by the combination of high system sensitivity to initial conditions and a bounded output. Some chaotic systems include a non-linear or piecewise linear element within a feedback path. Various ways of producing a chaotic system can be used, including for example, coupled nonlinear L-C oscillators, non-linear feedback oscillators, and the like. FIG. 5 illustrates one example of a relatively simple electrical circuit that produces chaotic output when the input frequency of the sinusoidal voltage source is close to the resonant frequency of the circuit. It will be appreciated that other chaotic circuits may also be used.

In addition to helping to disrupt the wavefront uniformity of the individual light emitters, the perturbation modulators 104 can also help to reduce interference that may occur between overlapping portions of adjacent patches in the image. Overlap may intentionally be included, for example, to provide smoothing of pixilation in the projected image. Overlap may unintentionally be included, for example, due to alignment errors in the optical system. Adjacent light emitters, if coherent, may cause constructive or destructive interference, resulting in visible artifacts or interference patterns. By including the perturbation modulators, this helps avoid these effects.

A method for reducing speckle in an image projected by an array of laser light emitters will now be described in conjunction with the flowchart of FIG. 6. The method 600 may include the step of forming 602 an image using a plurality of light emitters. Each light emitter can form a portion of the image. For example, the laser light emitter may form one or more pixels of the image as described above. More particularly, the laser light emitters may form N×M pixel patches of the image, wherein N and M are positive integers. Various light emitters can be used, including for example VCSELs as described above.

The method may also include the step of non-mechanically perturbing 604 an input to the plurality of light emitters to a degree sufficient to disrupt waveform uniformity to reduce speckle in the image. For example, perturbing an input can be performed by modulating a drive current of the laser light emitters using a chaotic signal. As another example, perturbing an input can be providing feedback of optical output from the light emitters.

Summarizing and reiterating to some extent, the disclosed techniques can help to provide increased image brightness in a projection system by using an array of laser light emitters to cooperatively project the image. Because multiple light emitters are used, brightness of the image can be increased without increasing the brightness of individual emitted laser beams. To help reduce speckle, coherence of the emitted laser light can be reduced using chaotic circuits to modulate drive current of the laser light emitters. The high directionality provided by the laser light emitters can also help to simplify overall design and improve efficiency of the projector system, since fewer or simpler lenses may be used. Because many low power laser light emitters can be used, overall power efficiency and reliability of the projector may also be improved.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A projection system comprising:
an array of laser light emitters, each laser light emitter being capable of emitting a beam to form a portion of an image; and
a plurality of perturbation modulators non-mechanically coupled to corresponding laser light emitters to vary an input to the light emitter sufficiently to disrupt wavefront uniformity across the array of laser light emitters.

2. The system of claim 1, wherein each laser light emitter forms a single pixel of the image.

3. The system of claim 1, further comprising an optical scanning subsystem, wherein each laser light emitter is scanned to form multiple pixels of the image.

4. The system of claim 1, wherein the laser light emitter is a vertical-cavity surface-emitting laser.

5. The system of claim 1, wherein the array of laser light emitters is a plurality of vertical-cavity surface-emitting lasers fabricated on a common substrate.

6. The system of claim 1, wherein the laser light emitter comprises a red light emitter, a green light emitter, and a blue light emitter.

7. The system of claim 1, wherein the laser light emitter is an ultraviolet light emitter.

8. The system of claim 1, wherein the input is a drive current for the laser light emitter.

9. The system of claim 8, wherein the perturbation modulator comprises a chaotic signal generator to produce a chaotically varying signal as the drive current.

10. The system of claim 1, wherein the perturbation modulator comprises a mirror positioned to reflect a portion of the beam back into the laser light emitter.

11. A projection system comprising:
a plurality of means for emitting laser light to cooperatively form an image;
a means for non-mechanically perturbing the plurality of means for emitting laser light so as to disrupt wavefront uniformity across the image sufficiently to reduce speckle in the image.

12. The system of claim 11, wherein the means for non-mechanically perturbing comprises means for chaotically varying an electrical input to the means for emitting laser light.

13. The system of claim 11, wherein the means for non-mechanically perturbing comprises means for optically reflecting a portion of emitted laser light back into the means for emitting laser light.

14. A method for reducing speckle in an image projected by an array of light emitters, the method comprising:
forming an image defined at least in part by a wavefront projected by a plurality of laser light emitters driven by at least one input, each laser light emitter forming a portion of the image; and
non-mechanically perturbing the input to a degree sufficient to disrupt wavefront uniformity whereby speckle in the image is reduced.

15. The method of claim 14 wherein forming an image comprises producing a plurality of pixels of the image using one laser light emitter to produce each pixel.

16. The method of claim 14 wherein forming an image comprises producing a plurality of pixels of the image using one laser light emitter to produce a subset of N×M of the pixels, wherein N and M are each positive integers.

17. The method of claim 14, wherein non-mechanically perturbing an input comprises electrically perturbing the input to the laser light emitters.

18. The method of claim 14 wherein non-mechanically perturbing an input comprises modulating a drive current of the plurality of laser light emitters with a chaotic signal.

19. The method of claim 14 wherein non-mechanically perturbing an input comprises optically feeding back a portion of the wavefront into the laser light emitters.
